(19) United States
(12) Patent Application Publication
(10) Pub. No.: US 2015/0020522 A1
(43) Pub. Date: Jan. 22, 2015

(54) ENGINE SYSTEM

(71) Applicant: Hyundai Motor Company, Seoul (KR)

(72) Inventors: Jong Il Park, Seoul (KR); Seung Kook Han, Suwon-si (KR); Hyeon Ho Kim, Yongin-si (KR); II Joong Hwang, Gunpo-si (KR); Dong Ho Chu, Ansan-si (KR); Yoon Joo Kim, Yongin-si (KR); Dong Hee Han, Seoul (KR); Hyuk Im, Suwon-si (KR); Hyun Jun Lim, Incheon (KR)

(73) Assignee: Hyundai Motor Company, Seoul (KR)

(21) Appl. No.: 14/073,725

(22) Filed: Nov. 6, 2013

(30) Foreign Application Priority Data
Jul. 18, 2013 (KR) 10-2013-0084907

(51) Int. Cl. F02B 37/16; F02B 29/04

(52) U.S. Cl. CPC F02B 37/164; F02B 29/04
USPC 60/599; 60/602

(57) ABSTRACT

An engine system may include a first intake line connected to an intake manifold and supplying the intake manifold disposed on a cylinder block with outside air, an intake bypass valve disposed on the first intake line, a second intake line that bypasses the first intake bypass valve to the intake manifold, a first exhaust line through which exhaust gas flows from an exhaust manifold disposed on the cylinder block, an exhaust bypass valve disposed on the first exhaust line, a second exhaust line connected to the exhaust manifold and bypasses the exhaust bypass valve, a turbo charger disposed between the second intake line and the second exhaust line and operated by exhaust gas passing the second exhaust line to pump intake air flowing the second intake line, and a control portion that controls the intake bypass valve and the exhaust bypass valve depending on a driving condition.

### CROSS-REFERENCE TO RELATED APPLICATION

The present application claims priority to Korean Patent Application No. 10-2013-0084907 filed on Jul. 18, 2013, the entire contents of which is incorporated herein for all purposes by this reference.

### BACKGROUND OF THE INVENTION

1. Field of the Invention

The present invention relates to an engine system that uses turbo charger and recirculates exhaust gas to improve output, combustion efficiency, and quality of exhaust gas in a low speed area.

2. Description of Related Art

Generally, it has been known that a diesel engine consumes less fuel and has better efficiency than a gasoline engine. The diesel engine outputs efficiency of about 40% and this is realized by high compression ratio.

Recently, a turbo charger and an intercooler are further disposed to realize large output from a gasoline engine and a diesel engine.

An engine having the turbo charger sucks exhaust gas or outside air through a compressor of a turbo charger to compress them, and the compressed high temperature air is supplied to an engine side.

However, rapidly compressed air absorbs heat of a turbo charger and is heated in the compression process in such a way that the density thereof is lowered, and resultantly charging efficiency of an engine combustion chamber is deteriorated. Thus, an intercooler is used to cool the compressed air to realized high density, and as a result, larger amount of air is supplied to the engine combustion chamber to obtain high output.

Meanwhile, in an engine having a turbo charger, researches for reducing fuel consumption and simultaneously increasing output torque in a middle and a low speed area has been being undertaken, and researches for efficiently controlling the recirculated exhaust gas has been being undertaken together.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an engine system having advantages of reducing fuel consumption and increasing output torque in a condition that an engine having a turbo charger is in a predetermined middle and low speed area.

In an aspect of the present invention, an engine system may include a first intake line that is connected to an intake manifold and supplies the intake manifold disposed on a cylinder block with outside air, an intake bypass valve that is disposed on the first intake line, a second intake line that bypasses the first intake bypass valve to the intake manifold, a first exhaust line through which exhaust gas flows from an exhaust manifold disposed on the cylinder block, an exhaust bypass valve that is disposed on the first exhaust line, a second exhaust line that is connected to the exhaust manifold and bypasses the exhaust bypass valve, a turbo charger that is disposed between the second intake line and the second exhaust line and is operated by exhaust gas passing the second exhaust line to pump intake air flowing the second intake line, and a control portion that controls the intake bypass valve and the exhaust bypass valve depending on a driving condition.

The engine system may include an intercooler that is disposed on the second intake line at a downstream side of a compressor of the turbo charger.

The engine system may include a throttle body that controls intake air amount that is supplied to the intake manifold.

The first intake line and the second intake line are connected to the throttle body.

The control portion opens the intake bypass valve and the exhaust bypass valve and controls opening rate of the exhaust bypass valve, when it is determined that a load is less than a predetermined value in an area in which a RPM is less than a predetermined value.

The control portion closes the intake bypass valve, opens the exhaust bypass valve, and controls opening rate of the exhaust bypass valve, when it is determined that a load is less than a predetermined value in an area in which a RPM is less than a predetermined value.

The control portion opens the intake bypass valve and the exhaust bypass valve and controls output by controlling opening rate of the exhaust bypass valve in an area in which a RPM is higher than a predetermined value.

Air flowing rate coefficient of the turbo charger is less than 2 based on the air flowing rate passing a compressor and wherein the air flowing rate coefficient is equal to a compressor passing maximum air flowing rate (kg/h)/a piston displace amount (L).

The second intake line is diverged from an air cleaner box connected to the first intake line and sequentially passes a compressor of the turbo charger and an intercooler to join the first intake line.

The second exhaust line is diverged from the exhaust manifold and passes a turbine of the turbo charger to join the first exhaust line.

A capacity of the turbo charger is set to a minimum value that an engine of a natural intake type realizes maximum output torque in a predetermined low speed area.

In accordance with the present invention for realizing the object, a turbo charger is used to supply air in a predetermined rotation low speed area of a conventional natural intake type gasoline engine in such a way that torque is increased and fuel consumption is reduced in a low speed area.

Also, it easily realizes effects in which a natural intake method is used to output a high torque in a high speed area and a small turbo charger is used to increase torque in a low speed area. That is, a turbo charger is used to super charge air in a low speed area lower than a maximum torque point and a natural intake method can be maintained in a high speed area.

Accordingly, because a turbo charger is only used in a low speed area that a driver relatively frequently uses, a capacity of a turbo charger can be reduced and a low speed torque can be increased to reduce fuel consumption.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an engine system according to an exemplary embodiment of the present invention.

FIG. 2 is a graph showing objects and effects of an engine system according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

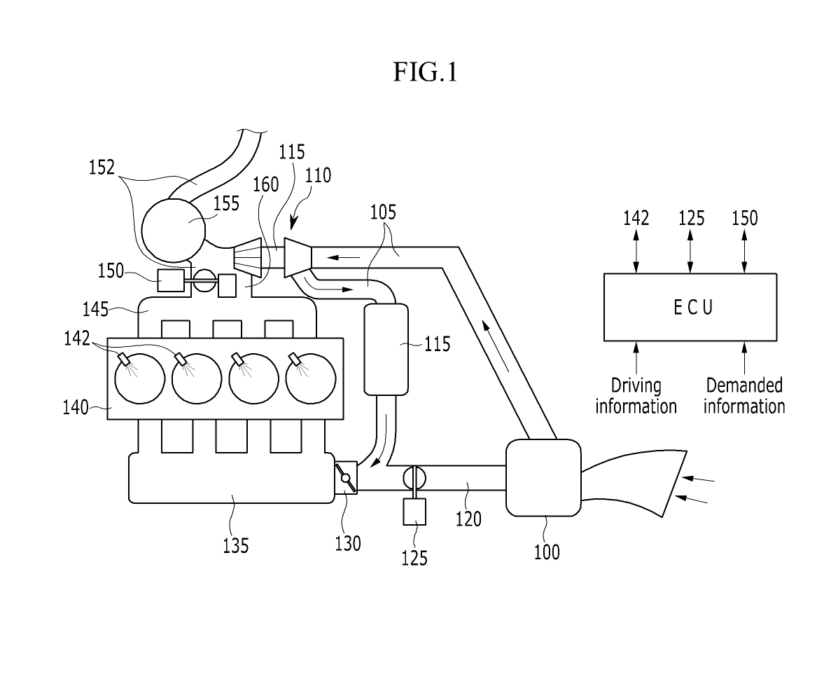

FIG. 1 is a schematic diagram of an engine system according to an exemplary embodiment of the present invention.

Referring to FIG. 1, an engine system includes an air cleaner box 100, a first intake line 120, a second intake line 105, a throttle body 130, an intake manifold 135, a cylinder block 140, an injector 142, an exhaust manifold 145, a first exhaust line 152, an exhaust bypass valve 150, a catalyst 155, a second intake line 105, an intercooler 115, a second exhaust line 160, a turbo charger 110, and a control portion (ECU).

The second intake line 105 bypasses the intake bypass valve 125, is diverged from the air cleaner box 100, and passes a compressor 115 of the turbo charger 110 and the intercooler 115 to join the first intake line 120.

The throttle body 130 is disposed at a downstream side of a point that the first intake line 120 joins the second intake line 105. Here, the second intake line 105 is not diverged from the air cleaner box 100 and can be diverged from the first intake line 120.

The first exhaust line 152 is diverged from the exhaust manifold 145 and the exhaust bypass valve 150 and the catalyst 155 are sequentially disposed on the first exhaust line 152.

The second exhaust line 160 bypasses the exhaust bypass valve 150 and is diverged from the exhaust manifold 145 to join the first exhaust line 152 between the exhaust bypass valve 150 and the catalyst 155. Here, the second exhaust line 160 is not from the exhaust manifold 145 and can be diverged from the first exhaust line 152.

Intake air is supplied to the intake manifold 135 through a compressor 115 of the turbo charger 110 and the intercooler 115 of the second intake line 105 in a condition in which the control portion (ECU) closes the intake bypass valve 125 in an exemplary embodiment of the present invention.

Further, intake air is supplied to a combustion chamber of a cylinder block 140 through the first intake line 120 and the throttle body 130 in a condition in which the control portion (ECU) opens the intake bypass valve 125.

If the control portion (ECU) completely opens the exhaust bypass valve 150, the exhaust gas passes catalyst of the first exhaust line 152 to be exhausted, and when the exhaust bypass valve 150 is closed, the exhaust gas operates a turbine of the turbo charger 110 and passes the catalyst 155 through the second exhaust line 160 to be exhausted.

The control portion (ECU) adjusts opening rate of the exhaust bypass valve 150 to control the operation of the turbo charger 110, detects demand condition of a driver like an accelerator sensor and a brake sensor and a driving condition of an engine to determine demand torque, and can control the intake bypass valve 125, the exhaust bypass valve 150, and the injector 142 to inject fuel.

In an exemplary embodiment of the present invention, the turbo charger 110 is used to super charge intake air to increase in a low speed torque in a low speed area lower than a predetermined value on a natural intake type gasoline engine and a natural intake method can maintain the performance without help of the turbo charger 110 at a high speed area higher than a predetermined value.

Further, the capacity of the turbo charger 110 is less than 2 based on an air flowing amount coefficient. Here, the air flowing amount coefficient=compressor passing maximum flowing amount (kg/h)/piston displacement (L).

And, the super charging of the turbo charger 110 can be performed at a condition lower than a predetermined engine speed in which a maximum torque is generated in a natural intake type engine. Accordingly, the intake bypass valve 125 and the exhaust bypass valve 150 are completely opened at a condition lower higher than the predetermined engine speed to be able to realize performance similar or equal to the natural intake type engine.

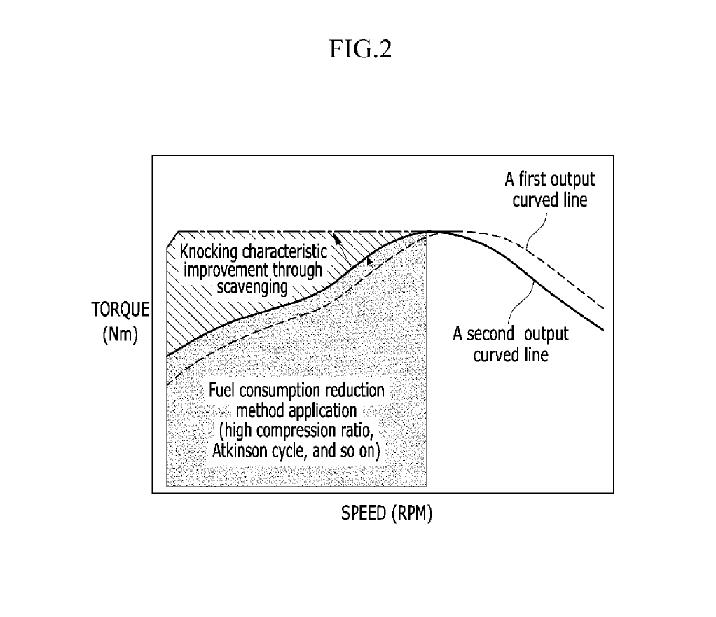

FIG. 2 is a graph showing objects and effects of an engine system according to an exemplary embodiment of the present invention.

Referring to FIG. 2, a horizontal axis denotes a rotation speed of an engine and a vertical axis denotes an output of an engine.

Generally, an engine has a characteristic of a first output curved line and a second output curved line. That is, the first output curved line shows an engine characteristic outputting low torque in a low speed and high torque in a high speed, and the second output curved line shows an engine characteristic outputting relative high torque in a low speed are and relative low torque in a high speed area.

And, scavenging of cylinder combustion gas is performed so as to increase a torque and reduce knocking phenomenon in a low speed area, and a low speed torque can be increased through high compression ratio or Atkinson cycle, but the control thereof is complicated and the further structure is needed.

However, it easily realizes effects by using a small turbo charger 110 to realize high torque in a high speed area and maintain high torque through a natural intake method in a high speed area in an exemplary embodiment of the present invention.

That is, the turbo charger 110 is used in a low speed area lower than a maximum torque point to super charge intake air, and a natural intake method can be maintained in a high speed area.

Accordingly, because the turbo charger 110 is used only in a low speed area that a driver frequently uses, the capacity of the turbo charger 110 and the low speed torque can be increased to reduce fuel consumption.

The capacity of the turbo charger 110 can be set to a minimum value that a natural intake type engine can realize a maximum output torque in a low speed area in an exemplary embodiment of the present invention.

For convenience in explanation and accurate definition in the appended claims, the terms “upper”, “lower”, “inner” and “outer” are used to describe features of the exemplary embodiments with reference to the positions of such features as displayed in the figures. The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. They are not intended to be exhaustive or to limit the invention to the precise forms disclosed, and obviously many modifications and variations are possible in light of the above teachings as well as various alternatives and modifications thereof. It is intended that the scope of the invention be defined by the Claims appended hereto and their equivalents

What is claimed is:

1. An engine system, comprising:
a first intake line that is connected to an intake manifold and supplies the intake manifold disposed on a cylinder block with outside air;
an intake bypass valve that is disposed on the first intake line;
a second intake line that bypasses the first intake bypass valve to the intake manifold;
a first exhaust line through which exhaust gas flows from an exhaust manifold disposed on the cylinder block;
an exhaust bypass valve that is disposed on the first exhaust line;
a second exhaust line that is connected to the exhaust manifold and bypasses the exhaust bypass valve;
a turbo charger that is disposed between the second intake line and the second exhaust line and is operated by exhaust gas passing the second exhaust line to pump intake air flowing the second intake line; and
a control portion that controls the intake bypass valve and the exhaust bypass valve depending on a driving condition.

2. The engine system of claim 1, comprising an intercooler that is disposed on the second intake line at a downstream side of a compressor of the turbo charger.

3. The engine system of claim 1, comprising a throttle body that controls intake air amount that is supplied to the intake manifold.

4. The engine system of claim 3, wherein the first intake line and the second intake line are connected to the throttle body.

5. The engine system of claim 1, wherein the control portion opens the intake bypass valve and the exhaust bypass valve and controls opening rate of the exhaust bypass valve, when it is determined that a load is less than a predetermined value in an area in which a RPM is less than a predetermined value.

6. The engine system of claim 1, wherein the control portion closes the intake bypass valve, opens the exhaust bypass valve, and controls opening rate of the exhaust bypass valve, when it is determined that a load is less than a predetermined value in an area in which a RPM is less than a predetermined value.

7. The engine system of claim 1, wherein the control portion opens the intake bypass valve and the exhaust bypass valve and controls output by controlling opening rate of the exhaust bypass valve in an area in which a RPM is higher than a predetermined value.

8. The engine system of claim 1, wherein air flowing rate coefficient of the turbo charger is less than 2 based on the air flowing rate passing a compressor and wherein the air flowing rate coefficient is equal to a compressor passing maximum air flowing rate (kg/h)/a piston displace amount (L).

9. The engine system of claim 1, wherein the second intake line is diverged from an air cleaner box connected to the first intake line and sequentially passes a compressor of the turbo charger and an intercooler to join the first intake line.

10. The engine system of claim 1, wherein the second exhaust line is diverged from the exhaust manifold and passes a turbine of the turbo charger to join the first exhaust line.

11. The engine system of claim 1, wherein a capacity of the turbo charger is set to a minimum value that an engine of a natural intake type realizes maximum output torque in a predetermined low speed area.
